(19) United States
(12) Patent Application Publication
(10) Pub. No.: US 2007/0126259 A1
(43) Pub. Date: Jun. 7, 2007

(54) Unit carrier comprising an integrated lock fixing system for a motor vehicle door

(76) Inventors: Pedro Almeida, Osnabruck (DE); Thomas Kreitz, Solingen (DE)

Correspondence Address: WILLIAM COLLARD;COLLARD & ROE, P.C., 1077 NORTHERN BOULEVARD, ROSLYN, NY, 11576, US

(21) Appl. No.: 10/579,187

(22) PCT Filed: Jul. 28, 2004
(86) PCT No.: PCT/EP04/08427

§ 371 Date: Oct. 3, 2006

(30) Foreign Application Priority Data
Nov. 14, 2003 (DE) 203 17 708.8

(51) Int. Cl. B60J 5/00

(52) U.S. Cl. 296/146.1

(57) ABSTRACT

The invention relates to a unit carrier (1) for a motor vehicle door, with at least one fixing section for a door lock (3) and fixing points for securing the unit carrier to a motor vehicle door, wherein the door lock can be connected by a lock holding angle (4) to the unit carrier. According to the invention a snap-in connection is provided between the lock holding angle (4) and the unit carrier (1) so that the lock holding angle (4) can be secured by means of a catch mechanism to the unit carrier (1). Consequently the assembly work in securing the door lock (3) to the unit carrier (1) is considerably reduced.

The invention relates to a unit carrier for a motor vehicle door, with at least one fixing section for a door lock and fixing points for securing the unit carrier to a motor vehicle door, wherein the door lock can be connected by a lock holding angle to the unit carrier.

Such a unit carrier comprises at least one fixing section for a door lock and a plurality of fixing points for securing the unit carrier to a motor vehicle door, wherein the door lock can be pre-assembled with the unit carrier by means of a lock holding angle for assembly and transport purposes. Such a unit carrier is also referred to as a door module support and serves to support different functional components of a motor vehicle door, e.g. a window winder, a door lock, a lateral airbag, loudspeakers, etc. The functional components may be pre-assembled on each unit carrier, wherein the unit carrier then forms a complete prefabricated door module which is inserted in a motor vehicle door. For this purpose the unit carrier is secured together with the functional components fastened to it to the vehicle door, normally to the inner door plate.

The door lock is secured to the unit carrier using a lock holding angle which is fastened to the unit carrier. After the door lock is pre-positioned for subsequent installation in the motor vehicle door, the lock is finally positioned by means of screws which are guided through openings in the door shell and are screwed with threaded holes formed in the lock housing.

The lock is normally connected to the lock holding angle for pre-positioning the lock by riveting holes that lie in alignment with each other in the lock holding angle and the lock. Besides the additional operation of riveting the lock and lock holding angle for pre-positioning the lock, additional fixing parts, in the form of rivets, are therefore required. It is only possible to loosen this riveted connection by drilling out the rivets. Both riveting for pre-positioning the lock on the lock holding angle and possible loosening of the connection between the lock holding angle and the lock are labour and cost intensive. Moreover, the lock or lock holding angle may be damaged if the connection is loosened by drilling out the rivets.

To overcome these disadvantages a device has already been proposed in which a snap-in connection is provided between the door lock and lock holding angle (cf. DE 201 11 158 U1). In this device of prior art the lock holding angle is connected via holes to a unit carrier plate in the motor vehicle door by means of a riveted or screwed connection.

The object of the present invention is to optimise the assembly work in securing a motor vehicle door lock to a unit carrier (door module support) that can be inserted in a motor vehicle door.

This object is achieved according to the invention in a unit carrier of the type mentioned in the introduction by providing a snap-in connection between the lock holding angle and the unit carrier. The lock holding angle may therefore be fastened by a simple snap-in locking to the unit carrier for pre-assembling the door lock, whereby considerable time saving is achieved in pre-assembling the door lock, and additional fixing means, such as rivets or screws, for securing the door lock and the lock holding angle to the unit carrier, may be completely dispensed with.

The lock holding angle may be rigidly connected to the door lock. According to an advantageous embodiment of the invention provision is made, in particular, for the lock holding angle to be designed integrally with a housing of the door lock. This enables the required assembly time to be further shortened and the number of parts reduced.

Another advantageous embodiment of the solution according to the invention is characterised in that the lock holding angle is designed with a cover that can be connected, preferably locked, to the door lock. This embodiment also provides further shortening of the assembly time and reduces the number of parts to be assembled.

The unit carrier preferably consists as much as possible of plastic manufactured in the injection moulding-foaming process (i.e. structural foam moulding process). Such a unit carrier is characterised by relatively low weight with sufficiently high strength, and load carrying capacity. A light unit carrier facilitates assembly and reduces the total weight and hence the fuel consumption of the motor vehicle. Moreover, because of the injected moulded-foamed plastic the unit carrier acts as a sound insulant, wherein the sound insulation is far better than in a corresponding unit carrier which is manufactured generally or as much as possible from sheet metal.

However, it also lies within the scope of the invention to manufacture the unit carrier of plastic in the injection moulding, injection compression moulding or compression moulding process.

The snap-in connection according to the invention may consist of at least one snap-in element formed on the lock holding angle and a snap-in retainer formed on the unit carrier and aligned with the snap-in element. Alternatively, however, the snap-in connection according to the invention may also be constructed from at least one snap-in element formed on the unit carrier and a snap-in retainer formed on the lock holding angle and aligned with the snap-in element.

The snap-in connection is preferably formed by at least one insert opening formed in the unit carrier and at least one plug-in that is formed on the lock holding angle and can be locked in the insert opening. Conversely, however, it is also possible to provide the insert opening on the lock holding angle and a plug-in element on the unit carrier that can be locked in the insert opening. Each of these embodiments guarantees a reliable connection of the lock holding angle and unit carrier.

A particularly robust connection of the lock holding angle and unit carrier is achieved especially when, according to a preferred embodiment of the invention, the snap-in connection is formed by a plurality of insert openings formed in the unit carrier and a plurality of plug-in elements that are formed on the lock holding angle and are lockable in the insert openings.

In a further preferred embodiment of the solution according to the invention the unit carrier has a plurality of ribs or bridges spaced a certain distance apart, in which insert openings are contained for at least one plug-in element formed on the lock holding angle.

This configuration provides a very robust fastening of the lock holding angle to the unit carrier with relatively low material consumption in the manufacture of the connecting elements of the snap-in connection.

An advantageous embodiment of the invention further consists in that the snap-in connection between the lock holding angle and the unit carrier is designed as a detachable clip connection. Consequently the connection between the lock holding angle and the unit carrier may, if necessary, be loosened without damage, particularly in the case of a repair.

The detachable clip connection is preferably made in such a manner that at least one snap-in projection that may be deflected by spring elasticity is formed on the plug-in element.

The plug-in element is here preferably of a catwalk design (toothed design), wherein the snap-in projection has a pressure face that is inclined in the direction of insertion and runs obliquely to the catwalk-shaped outer surface of the plug-in element, as well as a stop face that runs essentially perpendicularly to the catwalk-shaped outer surface of the plug-in element. This configuration guarantees a smooth snap-in connection which in principle can only be loosened by deflecting the snap-in projection by means of compressive force against its resilience.

Further preferred and advantageous embodiments of the invention are indicated in the subordinate claims.

The invention is explained in greater detail in the following with reference to a drawing showing several exemplary embodiments.

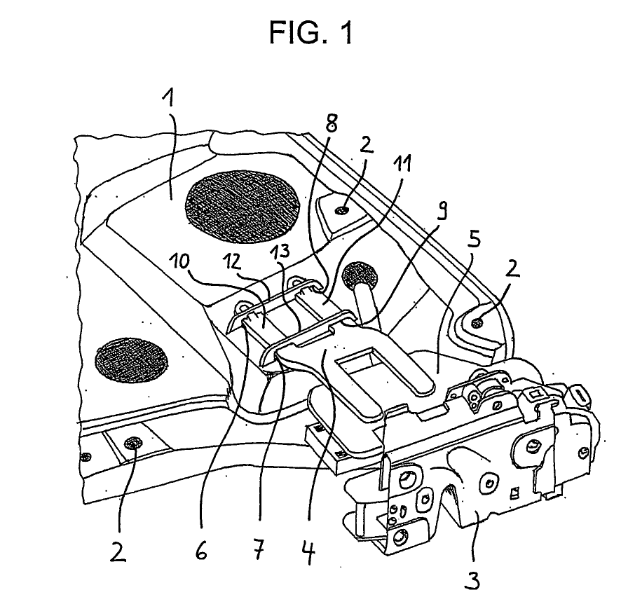

FIG. 1 shows a perspective view of a section of a unit carrier for installation in a motor vehicle door, to which a door lock is secured by means of a lock holding angle;

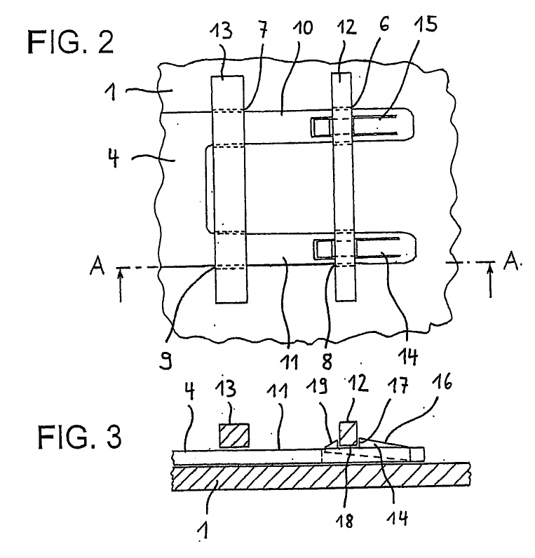

FIG. 2 shows an elevation of a section of a unit carrier according to FIG. 1 in the region of a lock holding angle secured to it;

FIG. 3 shows a sectional view along intersection line A-A in FIG. 2;

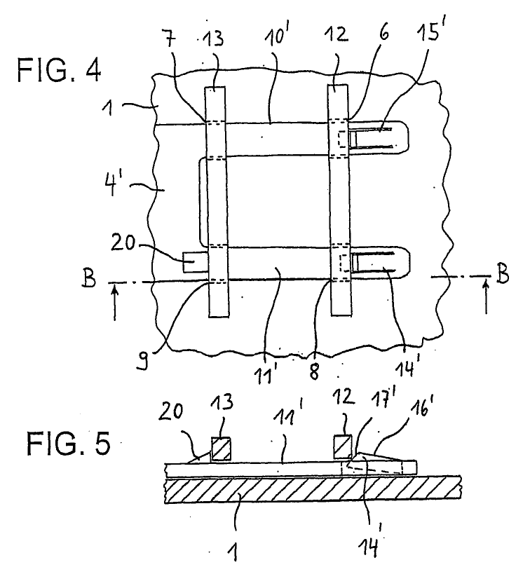

FIG. 4 shows an elevation of a section of the unit carrier according to FIG. 1 in the region of a lock holding angle secured to it, but differing from FIG. 2;

FIG. 5 shows a sectional view along intersection line B-B in FIG. 4;

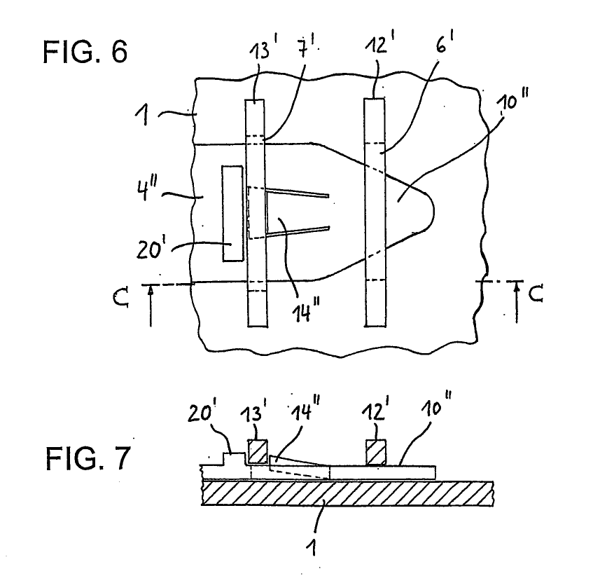

FIG. 6 shows an elevation of a section of a unit carrier in the region of a lock holding angle secured to it according to a further exemplary embodiment; and

FIG. 7 shows a sectional view along intersection line C-C in FIG. 6.

FIG. 1 shows a section of a unit carrier 1 of a motor vehicle door (not shown). Fixing points at which the unit carrier 1 can be detachably secured by means of clip connectors or screws to a motor vehicle door are denoted by 2. The unit carrier 1 consists essentially of plastic manufactured in the injection moulding-foaming process, and serves to support different functional components of the motor vehicle door, in particular the mounting of a door lock 3. Moreover, further functional components (not shown), for example, a window winder, an airbag, an energy absorption element for protecting a vehicle occupant and/or a loudspeaker, are mounted on the unit carrier 1.

The door lock 3 is connected by a lock holding angle 4 to the unit carrier 1, wherein a snap-in connection is provided between the lock holding angle 4 and the unit carrier 1 so that the lock holding angle 4 can be secured to the unit carrier 1 by locking. The snap-in connection between the lock holding angle 4 and the unit carrier 1 is designed as a detachable clip connection which comprises at least one snap-in element formed on the lock holding angle 4 and a snap-in retainer formed on the unit carrier 1 and aligned with the snap-in element.

The other end of the lock holding angle 4 is connected to a housing section or a cover 5 of the door lock 3, wherein the lock holding angle and the housing section or lock holding angle and the cover 5 may preferably also be designed integrally. The lock holding angle 4 and the cover 5 are made of plastic. The cover 5 protects the door lock 3 from moisture and/or manipulation.

As shown in FIG. 1, the snap-in connection has insert openings 6, 7, 8, 9 formed in the unit carrier 1 as a snap-in retainer and two plug-in elements 10, 11 that are formed on the lock holding angle 4 and can be locked in the insert openings. The insert openings 6, 7, 8, 9 are formed in ribs 12, 13 spaced a certain distance apart, which ribs are formed integrally on the unit carrier 1.

The lock holding angle 4 is of fork-shaped design, wherein the two plug-in elements 10, 11 form the fork-shaped insert end of the lock holding angle.

As shown in FIGS. 2 and 3, the plug-in elements 10, 11 each have a snap-in projection 14, 15, as a snap-in element that can be deflected by spring elasticity. To facilitate insertion of the plug-in elements 10, 11 in the insert openings 6, 7, 8, 9, their front ends are each tapered. The plug-in elements 10, 11 are designed essentially catwalk-shaped, wherein the snap-in projection 14 or 15, that can be deflected by spring elasticity, has a pressure face 16 that is inclined in the direction of insertion and runs obliquely to the catwalk-shaped outer surface of the plug-in element. The snap-in projection 14, 15 defined in the plug-in element 10, 11 by an essentially U-shaped slot, also has a catwalk-shaped design and has a groove 18 running transversely to the direction of insertion at its end facing away from the front end of the plug-in element 10, 11. The ribs 12, 13 are designed with different widths so that the groove 18 of the snap-in projection 14 or 15 does not interlock with the wide rib 13. The end of the snap-in projection facing away from the front end of the plug-in element 10, 11 is bevelled, wherein the upper side 19 is inclined against the direction of insertion of the plug-in element 10, 11 so that the snap-in projection 14 and 15 respectively are each pushed downwards when the plug-in elements 10, 11 are pulled out of the snap-in retainer on the wider rib. 13.

FIGS. 4 and 5 show a variant of the lock holding angle 4′. In this design the snap-in projection 14′, 15′ again has a pressure face 16′ that is inclined in the insertion direction and runs obliquely to the catwalk-shaped outer surface of the plug-in element 10′, 11′. In this case, however, the stop face 17′ is also formed obliquely to the catwalk-shaped outer surface of the plug-in element 10′ or 11′, wherein the stop face 17′ has a steeper inclination towards the catwalk-shaped outer surface of the plug-in element than the pressure face and is inclined so that it opposes the direction of insertion.

Because of the stop face 17′ running obliquely to the catwalk-shaped outer surface of the plug-in element, the lock holding angle 4′, in its engaged position, is secured sufficiently rigidly against a movement that loosen the connection to the unit carrier 1. In this design it is not necessary, in order to loosen the snap-in connection, for the snap-in projection 14′ or 15′ to be pressed down against its resilience by means of a compressive force. Because the snap-in connection can in this case also be loosened by pulling the plug-in element or plug-in elements 10′, 11′ of the lock holding angle 4′ with a certain tensile force out of the insert openings 6, 7, 8, 9 associated with them, wherein the stop face 17′ running obliquely is inclined so that the tensile force can be applied by a person without a tool or other aids.

In order to limit the depth of insertion of the lock holding angle 4′, at least one of the plug-in elements 10′, 11′ is provided with a stop 20 interacting with the rib 13.

FIGS. 6 and 7 show a further exemplary embodiment of the door lock fastening according to the invention, wherein the lock holding angle 4″ has only one plug-in element or insert end 10″. The plug-in element 10″ is in this case, therefore, not of a fork-shaped design, as is the case with the exemplary embodiments shown in FIGS. 1 to 5. The plug-in element (=insert end) 10″ of the lock holding angle 4″ has a tapered insert end which can be inserted in the insert openings 6′ and 7′ of the unit carrier 1 formed in the ribs 12′ and 13′. The insert end 10″ is provided as a snap-in element with a snap-in projection 14″, which can be deflected by spring elasticity and interacts with the rib 13′.

In order to limit the insertion depth of the lock holding angle 4″, a stop 20′ interacting with the rib 13′ is again provided on the insert end of the lock holding angle, as in the exemplary embodiment according to FIGS. 4 and 5.

The invention is not limited in its performance to the exemplary embodiments described above. On the contrary, a number of further variants are conceivable which, even in essentially differing design, also make use of the inventive concept contained in the claims. For example, the snap-in or clip connection according to the invention may also be designed in such a manner that only one single insert opening associated with the plug-in element is formed on the unit carrier 1. It is also within the scope of the invention for only one of the plug-in elements 10, 11 or 10′, 11′ to be provided with a snap-in projection 14 or 14′, according to FIG. 3 or FIG. 5, in a fork-shaped design of the lock holding angle 4, 4′.

Furthermore, it also lies within the scope of invention for the snap-in connection, contrary to the exemplary examples shown in the drawing, to be formed from at least one snap-in element formed on the unit carrier 1 and a snap-in retainer formed on the lock holding angle 4 and aligned with the snap-in element.

1-15. (canceled)

16. A unit carrier (1) for a motor vehicle door, with at least one fixing section for a door lock (3) and fixing points for securing the unit carrier to a motor vehicle door, wherein the door lock can be connected to the unit carrier by a lock holding angle (4, 4′, 4″) wherein a snap-in connection designed as a detachable clip connection is provided between the lock holding angle (4, 4′, 4″) and the unit carrier (1) so that the lock holding angle (4, 4′, 4) can be secured to the unit carrier (1) by means of a catch mechanism, wherein the snap-in connection is formed by a plurality of insert openings (6, 7, 8, 9; 6′, 7′) and at least one lockable plug-in element (10, 11; 10′, 11′; 10″) formed on the lock holding angle; and wherein the insert openings (6, 7, 8, 9; 6′, 7′) are contained in ribs (12, 13; 12′, 13′) formed on the unit carrier, which ribs are spaced a certain distance apart in the direction of insertion of the plug-in element.

17. The unit carrier according to claim 16, wherein the snap-in connection is formed by a plurality of plug-in elements (10, 11; 10′, 11′) that are formed on the lock holding angle (4, 4′) and can be locked in the insert openings.

18. The unit carrier according to claim 17, the lock holding angle (4, 4′) is of fork-shaped design, wherein a fork-shaped end of the lock holding angle is formed by the plug-in elements (10, 11; 10′, 11′).

19. The unit carrier according to claim 16, wherein at least one snap-in projection (14, 15; 14′, 15′; 14″) that can be deflected by spring elasticity is formed on the at least one plug-in element (10, 11; 10′, 11′, 10″).

20. The unit carrier according to claim 19, wherein the plug-in element (10, 11) is of a catwalk-shaped design, wherein the snap-in projection (14, 15) has a pressure face (16) that is inclined in the direction of insertion and runs obliquely to the catwalk-shaped outer surface of the plug-in element (10, 11), and a stop surface (17) that runs essentially perpendicularly to the catwalk-shaped outer surface of the plug-in element.

21. The unit carrier according to claim 19, wherein the plug-in element (10′, 11′) is of a catwalk-shaped design, wherein the snap-in projection (14′) has a pressure face (16′) that is inclined in the direction of insertion and runs obliquely to the catwalk-shaped outer surface of the plug-in element, and a stop face (17′) that runs obliquely to the catwalk-shaped outer surface of the plug-in element, wherein the stop face (17′) has a greater inclination to the catwalk-shaped outer surface of the plug-in element than the pressure face (16′) and is inclined so that it is opposed to the direction of insertion.

22. The unit carrier according to claim 16, wherein the lock holding angle (4, 4′) is rigidly connected to the door lock (3).

23. The unit carrier according to claim 16, wherein the lock holding angle (4, 4′, 4″) is designed integrally with a cover (5) that can be connected to, in particular locked to the door lock (3).

24. The unit carrier according to claim 16, wherein the lock holding angle (4, 4′, 4″) is designed integrally with a housing of the door lock (3).

25. The unit carrier according to claim 16, wherein it consists at least partially of plastic manufactured in the injection moulding-foaming process.
